(19) United States
(12) Patent Application Publication
(10) Pub. No.: US 2025/0307000 A1
(43) Pub. Date: Oct. 2, 2025

(54) SYSTEMS AND METHODS FOR GRAPHICS PROCESSING UNITS WITH ENHANCED RESOURCE BARRIERS

(71) Applicants: Advanced Micro Devices, Inc., Santa Clara, CA (US); ATI Technologies ULC, Markham (CA)

(72) Inventors: Priyadarshi Sharma, Santa Clara, CA (US); Travis Trapper Schluessler, Ft. Collins, CO (US); Saurabh Sharma, Folsom, CA (US); Josip Popovic, Markham (CA)

(73) Assignees: Advanced Micro Devices, Inc., Santa Clara, CA (US); ATI Technologies ULC, Markham (CA)

(21) Appl. No.: 18/622,770

(22) Filed: Mar. 29, 2024

(51) Int. Cl. G06F 9/50; G06T 15/00

(52) U.S. Cl. CPC G06F 9/5005; G06T 15/005

(57) ABSTRACT

A device can include a processor that is configured to execute instructions. These instructions cause the processor to direct at least one shader engine to execute a first task, during which the first task accesses a resource. The processor then directs the shader engine to initiate execution of a second task. This second task involves accessing the resource. The shader engine pauses the execution of the second task before accessing said resource. The processor subsequently receives a signal indicating that the resource is ready following the execution of the first task. Upon determining that the resource is now ready after the first task's execution, the processor directs the shader engine to resume execution of the second task.

### BACKGROUND

Graphics Processing Units (GPUs) can implement resource barriers to ensure proper sequencing of resource accesses.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is an illustration of an example task flow with a resource barrier.

FIG. 2 is an illustration of an example sequence for executing tasks with a resource barrier.

FIG. 3 is an illustration of an example sequence for executing tasks with an enhanced resource barrier.

FIG. 4 is a block diagram of an example graphics processing unit that applies enhanced resource barriers.

FIG. 5 is a block diagram of an example shader implementing an enhanced resource barrier.

FIG. 6 is a flow diagram of an example method for graphics processing units with enhanced resource barriers.

FIG. 7 depicts a block diagram of an example processing system including a graphics processing unit with enhanced resource barriers.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

Resource barriers can cause delay and idle time in GPUs as one task is blocked while waiting for another task to complete. Systems, devices, and methods described herein can implement enhanced resource barriers that mitigate delay and reduce wasted idle time in GPUs. For example, systems and methods implementing an enhanced resource barrier can allow for partial execution of a shader that access a resource that can not yet be ready (e.g., execution of the shader up to the first instruction that would access the resource), at which point these systems and methods can pause the shader until after the resource is ready (e.g., until after a cache invalidation operation following a write to the resource). In this manner, sequential tasks can be executed more quickly and/or GPU resources can be utilized more fully and/or efficiently.

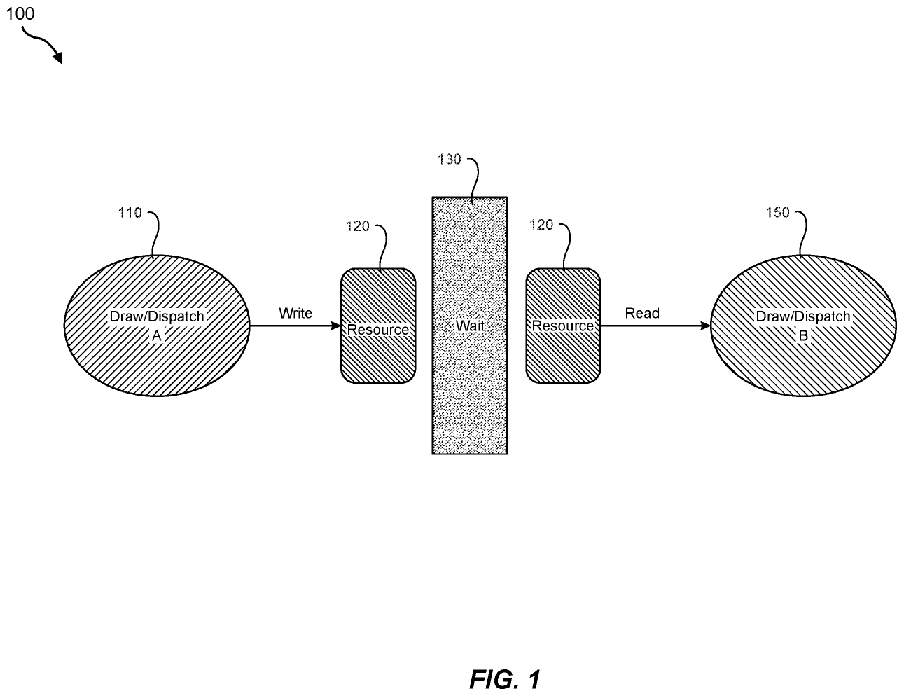

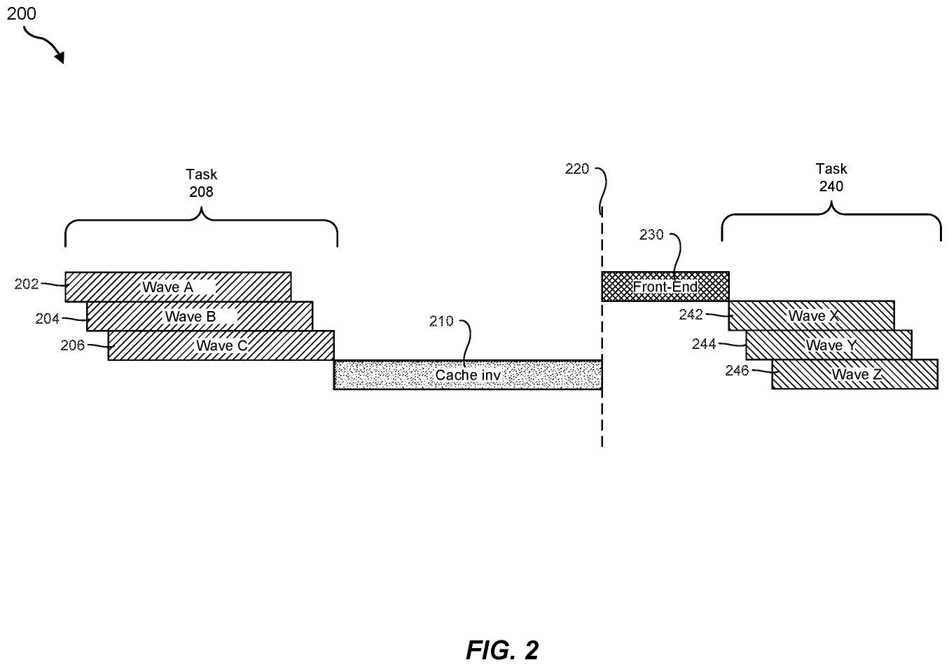

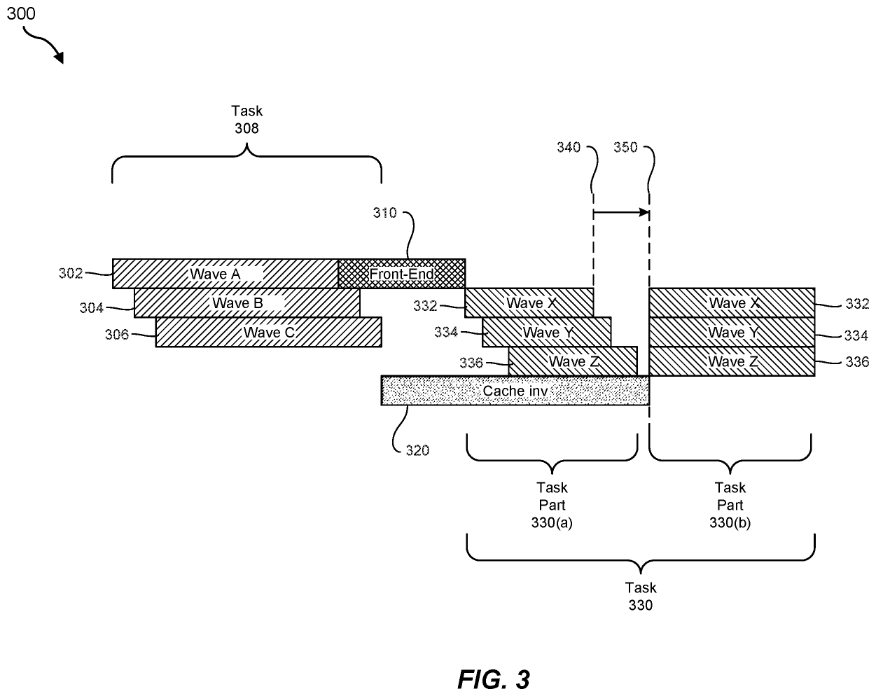

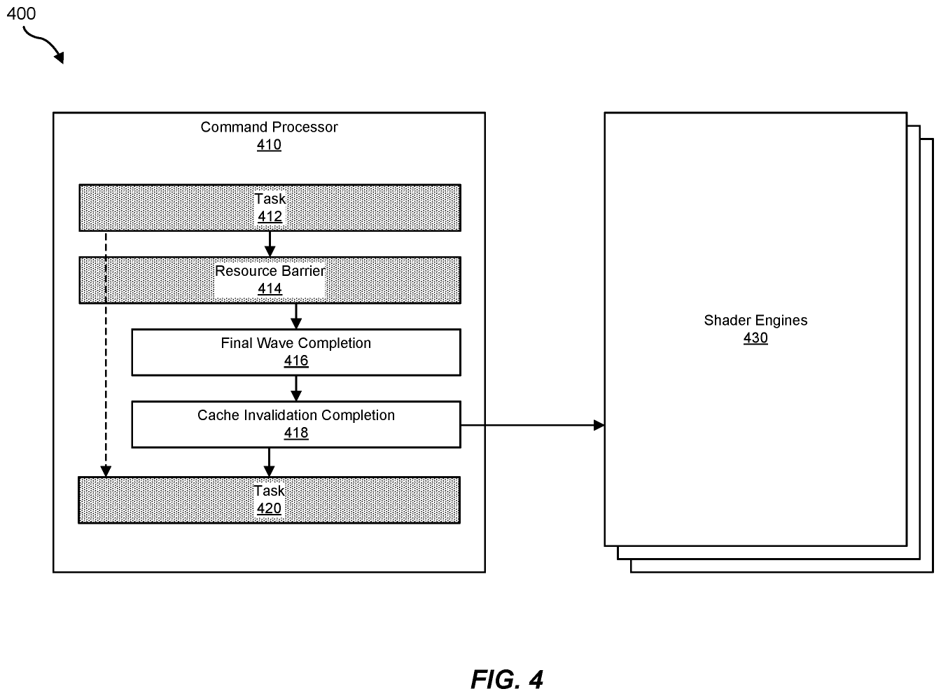

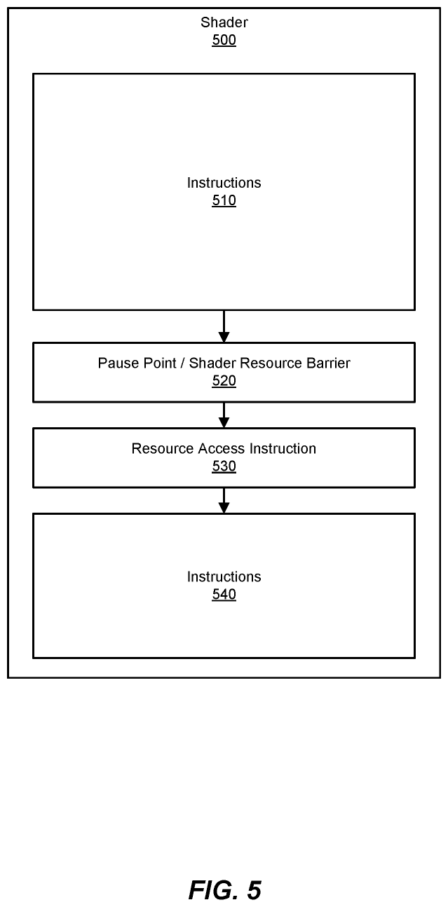

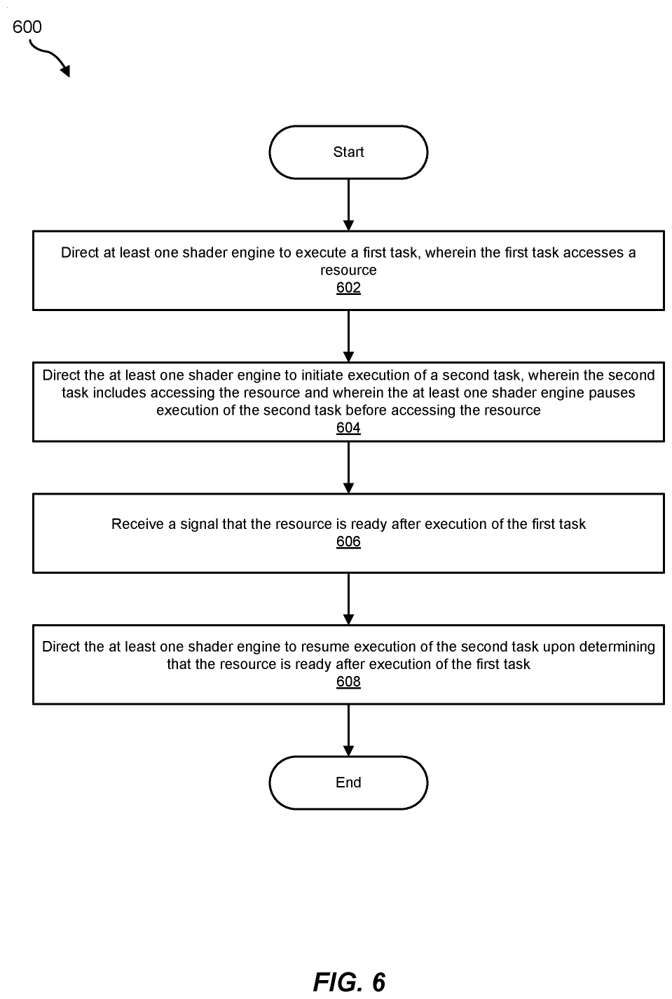

The following will provide, with reference to FIGS. 1-2, detailed descriptions of example illustrations of sequential task execution using resource barriers. Detailed descriptions of an example illustration of task execution using enhanced resource barriers will be provided in connection with FIG. 3. Detailed descriptions of example systems for enhanced resource barriers will be provided in connection with FIGS. 4-5. In addition, detailed descriptions of corresponding methods will also be provided in connection with FIG. 6.

A device can include a processor that is configured to execute instructions. These instructions cause the processor to direct at least one shader engine to execute a first task, during which the first task accesses a resource. The processor then directs the shader engine to initiate execution of a second task. This second task involves accessing the resource. The shader engine pauses the execution of the second task before accessing said resource. The processor subsequently receives a signal indicating that the resource is ready following the execution of the first task. Upon determining that the resource is now ready after the first task's execution, the processor directs the shader engine to resume execution of the second task.

In some examples, the first task can involve writing to the resource. Meanwhile, the second task can involve reading from the resource.

In some examples, the processor can additionally conducts a cache invalidation operation that pertains to the resource. The determination that the resource is ready after the first task's execution can be based on confirming that the cache invalidation operation has been completed.

In some examples, the execution of the second task can include the execution of multiple waves. The shader engine can pause the second task's execution before accessing the resource by pausing each individual wave in the collection of waves before that wave accesses the resource. The act of directing the shader engine to continue with the second task's execution can include guiding the shader engine to resume the execution of all the waves.

In some examples, the processor can also execute a front-end process for the second task before determining that the resource is ready for the second task.

In some examples, the processor additionally executes a front-end process for the second task prior to the first task's completion.

In some examples, a shader that carries out the second task can include a preliminary instruction which pauses the shader before another instruction that accesses the resource.

In some examples, the processor can also identify, within a shader that implements the second task, the position of the earliest instruction designated to access the resource. It then establishes, for that shader implementing the second task, a pause point before the position of this earliest instruction to halt the shader's execution.

A method can involve a control processor directing at least one shader engine to carry out a first task where the task accesses a resource. This control processor then directs the shader engine to start executing a second task. This task encompasses accessing the resource, but the shader engine pauses its execution before accessing the resource. The control processor then obtains a signal, which indicates that the resource is ready following the first task's completion. On determining that the resource is ready after the execution of the first task, the control processor guides the shader engine to continue the execution of the second task.

In some examples, the first task involves writing data to the resource, while the second task involves reading data from the resource.

In some examples, the method further includes performing a cache invalidation operation related to the resource. The resource's readiness after the first task's execution is determined by confirming the completion of the cache invalidation operation.

In some examples, the execution of the second task involves processing multiple waves. The shader engine pauses the execution of the second task by pausing each specific wave within the group of waves before that wave accesses the resource. Directing the shader engine to continue with the second task can involve guiding it to resume the execution of all these waves.

In some examples, the method can also include the execution of a front-end process for the second task before deciding that the resource is ready for this task.

With respect to the initial method, there is further execution of a front-end process for the second task prior to the completion of the first task.

In some examples, a shader that executes the second task can include an instruction that causes the shader to pause before a subsequent instruction which accesses the resource.

In some examples, the method can include identifying, within a shader that puts the second task into effect, the position of the earliest instruction set to access the resource. The method can then set, for that shader, a pause point before this location to halt the execution of the shader.

A system can include at least one shader engine and a control processor. This control processor is designed to execute instructions. These instructions lead the control processor to guide the shader engine to carry out a first task that includes accessing a resource. Following this, the control processor can direct the shader engine to initiate the execution of a second task. This second task can involve accessing the resource, but the shader engine pauses its execution before this access. After the first task's completion, the control processor can receive a signal indicating that the resource is ready. Once the resource's readiness is determined, the control processor can direct the shader engine to resume the second task's execution.

In some examples, the first task writes to the resource, and the second task reads from the resource.

In some examples, the control processor also conducts a cache invalidation operation that relates to the resource. The readiness of the resource after the execution of the first task is identified by confirming the completion of the cache invalidation operation. In some examples, the execution of the second task includes multiple waves. The shader engine pauses the execution of the second task before accessing the resource by pausing each wave within the group before it accesses the resource. The direction to the shader engine to proceed with the second task can involve instructing it to continue executing all the waves.

FIG. 1 is an illustration of an example task flow 100 with a resource barrier. As shown in FIG. 1, flow 100 can begin with a task 110 that involves a write operation to a resource 120. Resource 120 can represent any suitable resource that can be written to and read from by and/or within a hardware accelerator (such as a GPU). While, for convenience, various systems described herein can be referred to as a “GPU,” generally, “GPU” as used herein can equally refer to any hardware accelerator that can implement a resource barrier.

As used herein, the term “hardware accelerator” can refer to any hardware component adapted to efficiently perform specific computational tasks (e.g., as directed by and, thus, effectively offloaded from, a more general-purpose processor). In various examples, a hardware accelerator can be embedded within a system-on-chip (SoC), exist as a discrete component on a motherboard, or be part of a larger system infrastructure. Examples of hardware accelerators include, without limitation, GPUs, Tensor Processing Units (TPUs), Digital Signal Processors (DSPs), Field-Programmable Gate Arrays (FGPAs), and Application-Specific Integrated Circuits (ASICs).

As used herein, the term “resource barrier” can generally refer to a synchronization mechanism employed within a hardware accelerator to ensure proper sequencing and/or data coherency between different operations that access shared resources. Thus, resource barriers can contribute to preventing data races, inconsistencies, unintended overwrites, and the use of expired or incorrect data.

Taking a GPU as an example, examples of resource 120 can include, without limitation, a texture, a buffer, a frame buffer, a depth buffer, a stencil buffer, shared memory, and/or a query buffer. Examples of task 110 can include, without limitation, updating a texture, updating vertex buffer data with new positions or attributes, writing to a depth buffer or a stencil buffer, outputting pixel data to a frame buffer, and saving the output of a compute shader.

A task 150 can logically follow task 110 (e.g., can assume the results of task 110). In some examples, task 150 can involve a read operation from resource 120 (e.g., resource 120 as modified by task 110). However, in order to ensure that resource 120 (and the GPU) is in a proper state for task 150 to read from resource 120, a GPU can impose a wait 130 after task 110 is executed and before task 150 is executed.

FIG. 2 is an illustration of an example sequence 200 for executing tasks with a resource barrier. As shown in FIG. 2, sequence 200 can include the execution of a task 208 (e.g., that involves writing to a resource). Executing task 208 can include executing multiple waves, such as waves 202, 204, and 206. As used herein, the term “wave” can generally refer to any unit of execution within a hardware accelerator. In some examples, a wave can include one or more threads that execute concurrently. For example, a wave can execute according to a Single Instruction, Multiple Data (SIMD) model and/or a Single Instruction, Multiple Threads (SIMT) model. In various examples, one or more of the systems described herein can decompose a task into multiple waves and can execute these waves concurrently. Execution of the task can be completed following the completion of the execution of all of the waves and, in some examples, one or more clean-up operations.

In addition, as shown in FIG. 2, sequence 200 can include a cache invalidation operation 210. As used herein, the term “cache invalidation” can generally refer to any process whereby one or more portions of a cache are marked or otherwise designated as invalid and/or unusable. For example, when underlying data in a memory is cached, the underlying data in the memory can later change, making the cache no longer representative of the current state of the data. Accordingly, by invalidating the cache, an out-of-date version of the data cannot be retrieved from the cache. As can be appreciated, the completion of cache invalidation operation 210 before the resource written to by task 208 is read from can ensure that an up-to-date version of the resource is read from. In some examples, the term “cache invalidation” as used herein can also refer to a cache flushing operation (e.g., where one or more portions of a cache having the most up-to-date data (i.e., dirty lines) are written back to the next level of cache or memory hierarchy).

As shown in FIG. 2, sequence 200 can be divided by a resource barrier 220. Via resource barrier 220, a hardware accelerator can ensure that subsequent read operations that depend on the resource having been written to by task 208 are not performed before the resource is ready.

Sequence 200 can then include a set of front-end operations 230. As used herein, the term “front-end” as it applies to an operation or process generally refers to those operations and/or processes that are performed by a hardware accelerator in preparation for executing a task. Examples of front-end operations can include, without limitation, command fetching, command decoding, command validation, state management, and task routing.

Once the hardware accelerator has performed the set of front-end operations 230, sequence 200 can include the execution of a task 240 that depends on task 208. For example, task 240 can read from the resource that task 208 wrote to. Furthermore, the logic of task 240 can assume reading from the resource after task 208 has successfully written to the resource. Accordingly, waves 242, 244, and 246 can begin execution after resource barrier 220 (and, e.g., after the set of front-end operations 230). However, it can be appreciated that processing resources of the hardware accelerator (e.g., one or more shader engines) can be idle in the period between the execution of task 208 and the execution of task 240, potentially resulting in a slower overall performance of the hardware accelerator.

FIG. 3 is an illustration of an example sequence 300 for executing tasks with an enhanced resource barrier. As shown in FIG. 3, sequence 300 can first include a task 308. Task 308 can include the concurrent execution of waves 302, 304, and 306. Similar to sequence 200 of FIG. 2, following the completion of task 308 (e.g., of wave 306), sequence 300 can include a cache invalidation operation 320. However, in potential distinction from sequence 200 of FIG. 2, sequence 300 can include execution of a set of front-end operations 310 (for a task 330) before any resource barrier. For example, execution of the set of front-end operations 310 can be initiated before the cache invalidation operation 320 is initiated, concurrently with the cache invalidation operation 320, and/or before the cache invalidation operation 320 is completed. In one example, execution of the set of front-end operations 310 can be initiated before task 308 is completed (e.g., after the last wave of task 308, wave 306, has been issued by the control processor).

In addition, as can be appreciated, a task 330 that is dependent on task 308 (e.g., because task 330 includes at least one read operation from a resource written to by task 308) can be in two parts: a task part 330 (a) and a task part 330 (b). Specifically, task 308 can include waves 332, 334, and 336. Furthermore, waves 332, 334, and 336 can be divided into portions pertaining to task part 330 (a) and portions pertaining to task part 330 (b). For example, the portions pertaining to task part 330 (a) can include initial portions that do not depend on task 308 (e.g., do not include any read operation from the resource written to by task 308). However, the portions pertaining to task part 330 (b) can include subsequent portions that do depend on task 308 (e.g., do include one or more read operations from the resource).

In some examples, a resource barrier 340 can pause execution of each of waves 332, 334, and 336 before each respective wave reaches a read operation from the resource. Thus, for example, a shader can include an instruction inserted before the first read operation from the resource to pause (e.g., put to sleep) the shader. In another example, systems described herein can maintain metadata defining a pause point within each wave at which the wave is to be put to sleep (the metadata being based on the location within the instruction set of the first read instruction addressed from the resource). Systems described herein can define the pause point in any suitable way. In some examples, a pause point within the shader can be indicated before the shader is compiled (e.g., such that a task involving the shader can take advantage of the enhanced resource barrier techniques described herein). In some examples, a compiler can automatically identify an appropriate pause point (e.g., based on identifying a dependency or a potential dependency involving the resource and/or based on identifying a location of an earliest read operation from the resource). Additionally or alternatively, in some examples a compiler can, when compiling a shader, arrange one or more instructions of the shader to be before the pause point. Thus, for example, the compiler can order instructions within the shader such that one or more instructions that are not a part of an inter-task dependency (e.g., instructions that are not dependent on a read operation within the shader that, in turn, is dependent on the completion of a previous task) are executed before the pause point. In some examples, one or more systems can identify the appropriate pause point after compilation—e.g., before or during runtime. In some examples, the pause point may be conceived of and/or implemented as a shader resource barrier (e.g., a resource barrier set within a shader).

Once task 308 and related clean-up operations (e.g., cache invalidation operation 320) have completed, systems described herein can resume task 330 (e.g., continue with task part 330 (b) by waking up waves 332, 334, and 336) with a resume operation 350. As can be appreciated, by executing at least a portion of task 330 (i.e., task part 330 (a)) before the resource is ready, systems described herein can improve the speed performance of the hardware accelerator in executing sequential tasks with resource dependencies.

FIG. 4 is a block diagram of an example GPU 400 that applies enhanced resource barriers. As shown in FIG. 4, GPU 400 can include a command processor 410 and one or more shader engines 430. As used herein, the term “command processor” can refer to any module and/or component of a hardware accelerator that manages the execution and/or flow of tasks within the hardware accelerator. For example, a command processor can dispatch one or more tasks to one or more execution units within the hardware accelerator. In some examples, a command processor can translate Application Programming Interface (API) calls to the hardware accelerator into hardware-level instructions before dispatching the instructions to one or more execution units.

As used herein, the term “shader engine” can refer to any module and/or component of a hardware accelerator that performs the execution of shaders and/or other parallelized tasks. In some examples, a shader engine can include multiple compute units (e.g., shader cores) and can coordinate the execution of multiple threads in parallel.

As shown in FIG. 4, command processor 410 can dispatch a task 412 to one or more of shader engines 430. A resource barrier 414 can be defined between task 412 and a task 420 that depends on a resource handled by task 412. However, task 420 can begin execution after task 412, before a final wave completion 416 of task 412 and before a cache invalidation completion 418 following task 412. However, one or more devices and/or systems described herein (e.g., shader engines 430, one or more shader cores of shader engines 430 and/or command processor 410) can put pause waves of task 412 before the waves read from the resource. Then, once cache invalidation completion 418 is realized, command processor 410 can send one or more instructions to shader engines 430 to wake up the paused waves, such that task 420 is completed.

FIG. 5 is a block diagram of an example shader 500 implementing an enhanced resource barrier. As shown in FIG. 5, shader 500 can include initial instructions 510. Following instructions 510, shader 500 can include a pause point 520 (which may in some examples, as discussed earlier, be understood as a shader resource barrier). In some examples, pause point 520 is selected based on being directly before a resource access instruction 530. Thus, shader 500 can pause before resource access instruction 530 is executed. Pause point 520 can be implemented in any of a number of ways. In some examples, it can be defined within shader 500. In some examples, it can be defined by way of metadata associated with shader 500. As explained above, shader 500 can pause at pause point 520 until after the resource accessed by resource access instruction 530 is ready for access. Following resource access instruction 530, shader 500 can include additional instructions 540.

FIG. 6 is a flow diagram of an example method 600 for graphics processing units with enhanced resource barriers. The steps shown in FIG. 6 can be performed by any suitable devices, including one or more command processors of a hardware accelerator, one or more shader engines and/or shader cores of a hardware accelerator, and/or any other combination of modules including hardware, firmware, and/or computer-executable instructions. In one example, each of the steps shown in FIG. 6 can represent an algorithm whose structure includes and/or is represented by multiple sub-steps.

As illustrated in FIG. 3, at step 602 one or more of the systems described herein can direct at least one shader engine to execute a first task, where the first task accesses a resource. For example, command processor 410 of FIG. 4 can direct one or more of shader engines 430 to execute task 412.

At step 604 one or more of the systems described herein can direct the shader engine to initiate execution of a second task, where the second task includes accessing the resource and where the shader engine pauses execution of the second task before accessing the resource. For example, command processor 410 of FIG. 4 can direct one or more of shader engines 430 to initiate execution of task 420.

At step 606 one or more of the systems described herein can receive a signal that the resource is ready after execution of the first task. For example, command processor 410 of FIG. 4 can receive a signal that the resource is ready following the processing of resource barrier 414 (which may, in some examples, be implemented as an API command).

At step 608 one or more of the systems described herein can direct at least one shader engine to resume execution of the second task upon determining that the resource is ready after execution of the first task. For example, command processor 410 of FIG. 4 can direct one or more of shader engines 430 to resume execution of task 420.

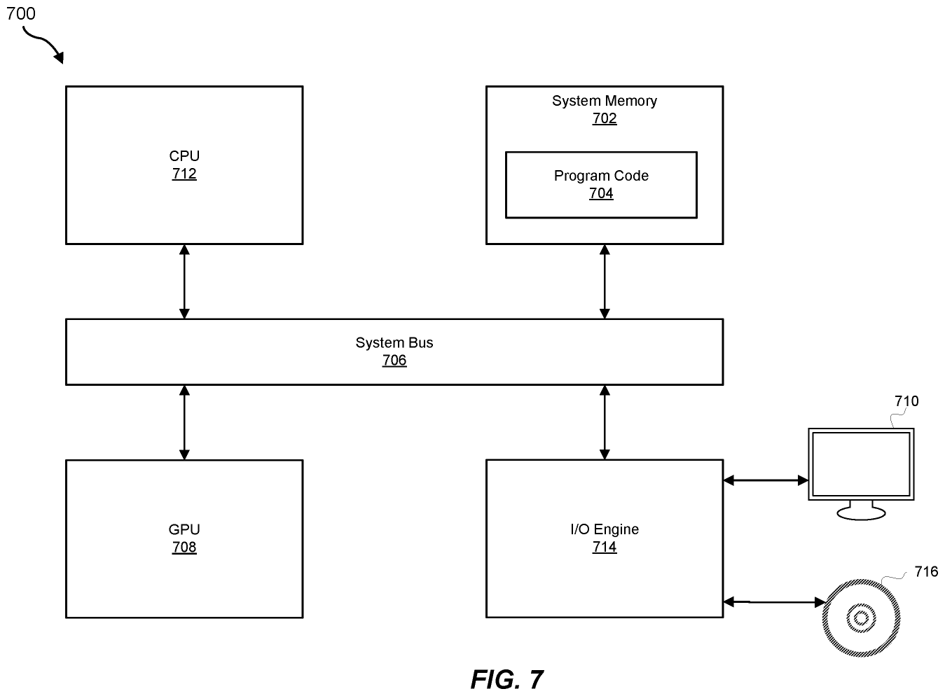

FIG. 7 depicts a block diagram of a processing system 700, according to some implementations of the present disclosure. The processing system 700 includes or has access to a system memory 702, implemented using a non-transitory computer-readable medium, such as dynamic random-access memory (DRAM). Additionally, the system memory 702 may also be implemented using other types of memory, including static random-access memory (SRAM), nonvolatile RAM (NVRAM), or spin-torque RAM (STRAM). The system memory 702, being external, is implemented outside the processing units of the processing system 700. Contained within the system memory 702 is program code 704, which comprises instructions executable by the processing system 700 to perform various operations. Furthermore, processing system 700 incorporates a system bus 706, facilitating communication between components within the system, such as the system memory 702 and the program code 704.

The processing system 700 is also equipped with a graphics processing unit (GPU) 708, designed to render images for display on a display unit 710. The GPU 708 is tasked with rendering graphical objects, producing pixel values supplied to the display unit 710, which then visualizes the images. Beyond image rendering, the GPU 708 is also capable of general-purpose computing, processing instructions from the program code 704 stored in system memory 702 and storing results back into it.

Processing system 700 also includes a central processing unit (CPU) 712, which connects to the rest of the system via system bus 706. The CPU 712 interfaces with both the GPU 708 and system memory 702 through the system bus 706, executing stored instructions and managing the data processing. It also plays a role in initiating graphics processing, sending commands to GPU 708 as required.

Additionally, the processing system 700 includes an input/output (I/O) engine 714, managing input and output operations related to various system components, including the display unit 710. The I/O engine 714, connected through system bus 706, facilitates interaction with other system components, such as system memory 702, GPU 708, and CPU 712. It manages various peripheral and external device communications and can interact with an external storage device 716, which is implemented as a non-transitory computer-readable medium like a compact disk (CD) or a digital video disc (DVD). The I/O engine 714 can both read from and write to the external storage device 716, enabling data storage and retrieval as part of the processing system's operations.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

According to various implementations, all or a portion of the devices, systems, and/or modules described herein can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processor configured to execute instructions that cause the processor to:
direct at least one shader engine to execute a first task, wherein the first task accesses a resource;
direct the at least one shader engine to initiate execution of a second task, wherein the second task includes accessing the resource and wherein the at least one shader engine pauses execution of the second task before accessing the resource;
receive a signal that the resource is ready after execution of the first task; and
direct the at least one shader engine to resume execution of the second task upon determining that the resource is ready after execution of the first task.

2. The device of claim 1, wherein:
the first task comprises writing to the resource; and
the second task comprises reading from the resource.

3. The device of claim 1, wherein:
the processor further performs a cache invalidation operation relating to the resource; and
determining that the resource is ready after execution of the first task comprises determining that the cache invalidation operation is complete.

4. The device of claim 1, wherein:
execution of the second task comprises execution of a plurality of waves;
the at least one shader engine pauses execution of the second task before accessing the resource by pausing execution of each given wave in the plurality of waves before accessing the resource in the given wave; and
directing the at least one shader engine to resume execution of the second task comprises directing the at least one shader engine to resume execution of the plurality of waves.

5. The device of claim 1, wherein the processor further executes a front-end process for the second task before determining that the resource is ready for the second task.

6. The device of claim 1, wherein the processor further executes a front-end process for the second task before completion of the first task.

7. The device of claim 1, wherein a shader implementing the second task comprises a first instruction to pause the shader before a second instruction to access the resource.

8. The device of claim 1, wherein the processor further:
identifies, within a shader implementing the second task, a location of an earliest instruction to access the resource; and
sets, for the shader implementing the second task, a pause point prior to the location of the earliest instruction to access the resource at which to pause execution of the shader.

9. A method comprising:
directing, by a control processor, at least one shader engine to execute a first task, wherein the first task accesses a resource;
directing, by the control processor, the at least one shader engine to initiate execution of a second task, wherein the second task includes accessing the resource and wherein the at least one shader engine pauses execution of the second task before accessing the resource;
receiving a signal, by the control processor, that the resource is ready after execution of the first task; and
directing, by the control processor, the at least one shader engine to resume execution of the second task upon determining that the resource is ready after execution of the first task.

10. The method of claim 9, wherein:
the first task comprises writing to the resource; and
the second task comprises reading from the resource.

11. The method of claim 9, further comprising:
performing a cache invalidation operation relating to the resource;
wherein determining that the resource is ready after execution of the first task comprises determining that the cache invalidation operation is complete.

12. The method of claim 9, wherein:
execution of the second task comprises execution of a plurality of waves;
the at least one shader engine pauses execution of the second task before accessing the resource by pausing execution of each given wave in the plurality of waves before accessing the resource in the given wave; and
directing the at least one shader engine to resume execution of the second task comprises directing the at least one shader engine to resume execution of the plurality of waves.

13. The method of claim 9, further comprising executing a front-end process for the second task before determining that the resource is ready for the second task.

14. The method of claim 9, further comprising executing a front-end process for the second task before completion of the first task.

15. The method of claim 9, wherein a shader implementing the second task comprises a first instruction to pause the shader before a second instruction to access the resource.

16. The method of claim 9, further comprising:
identifying, within a shader implementing the second task, a location of an earliest instruction to access the resource; and
setting, for the shader implementing the second task, a pause point prior to the location of the earliest instruction to access the resource at which to pause execution of the shader.

17. A system comprising:
at least one shader engine; and
a control processor configured to execute instructions that cause the control processor to:
direct the at least one shader engine to execute a first task, wherein the first task accesses a resource;
direct the at least one shader engine to initiate execution of a second task, wherein the second task includes accessing the resource and wherein the at least one shader engine pauses execution of the second task before accessing the resource;
receive a signal that the resource is ready after execution of the first task; and
direct the at least one shader engine to resume execution of the second task upon determining that the resource is ready after execution of the first task.

18. The system of claim 17, wherein:
the first task comprises writing to the resource; and
the second task comprises reading from the resource.

19. The system of claim 17, wherein:
the control processor further performs a cache invalidation operation relating to the resource; and
determining that the resource is ready after execution of the first task comprises determining that the cache invalidation operation is complete.

20. The system of claim 17, wherein:
execution of the second task comprises execution of a plurality of waves;
the at least one shader engine pauses execution of the second task before accessing the resource by pausing execution of each given wave in the plurality of waves before accessing the resource in the given wave; and
directing the at least one shader engine to resume execution of the second task comprises directing the at least one shader engine to resume execution of the plurality of waves.
